(19) United States
(12) Patent Application Publication
(10) Pub. No.: US 2024/0386748 A1
(43) Pub. Date: Nov. 21, 2024

(54) FACIAL TYPE DIAGNOSTIC DEVICE, FACIAL TYPE DIAGNOSTIC METHOD, AND PROGRAM

(71) Applicant: Panasonic Intellectual Property Management Co., Ltd., Osaka (JP)

(72) Inventors: Chie NISHI, Kanagawa (JP); Hiroki TAOKA, Kyoto (JP)

(73) Assignee: Panasonic Intellectual Property Management Co., Ltd., Osaka (JP)

(21) Appl. No.: 18/696,126

(22) PCT Filed: Aug. 24, 2022
(86) PCT No.: PCT/JP2022/031806

§ 371 Date: Mar. 27, 2024

(30) Foreign Application Priority Data
Oct. 1, 2021 (JP) 2021-162949

(51) Int. Cl. G06V 40/16

(52) U.S. Cl. CPC G06V 40/171; G06V 40/166; G06V 40/176

(57) ABSTRACT

This facial type diagnostic device has: an image acquisition unit for acquiring a first image capturing a first expression of a user, and a second image capturing a second expression of the user, a feature amount extraction unit for extracting a first feature amount of a facial part of the user in the first image, and a second feature amount of the facial part of the user in the second image; and a facial type determination unit for determining the facial type of the user on the basis of the first feature amount and the second feature amount.

### TECHNICAL FIELD

The present disclosure relates to a facial-type diagnostic apparatus, a facial-type diagnostic method, and a program.

### BACKGROUND ART

Patent Literature (hereinafter, referred to as “PTL”) 1 discloses an apparatus for diagnosing a facial type using facial feature points. The apparatus disclosed in PTL 1 acquires positional data of feature points of eyes, a face contour, a forehead, a chin, and the like from facial image data of a subject, and classifies the facial type of the subject into a preset facial type based on the positional data.

### CITATION LIST

### Patent Literature

PTL 1
U.S. Pat. No. 5,484,101

### SUMMARY OF INVENTION

However, in the prior art disclosed in PTL 1, a face shape is diagnosed based on the feature points acquired from a particular facial expression of the user, and thus, a deviation occurs between a comprehensive facial impression and a diagnosis result. For example, when the facial expression changes, the facial impression may change. In this respect, the prior art has a problem that this change cannot be reflected in the diagnosis result, and the facial type corresponding to the comprehensive facial impression of the user cannot be accurately diagnosed.

One non-limiting and exemplary embodiment of the present disclosure facilitates providing a facial-type diagnostic apparatus, a facial-type diagnostic method, and a program capable of improving the facial type diagnosis accuracy.

A facial-type diagnostic apparatus according to one exemplary embodiment of the present disclosure includes: an image acquirer that acquires a first image and a second image, the first image being a captured image of a first facial expression of a user, the second image being a captured image of a second facial expression of the user: a feature value extractor that extracts a first feature value of a facial part of the user in the first image and a second feature value of the facial part of the user in the second image; and a facial type determiner that determines a facial type of the user based on the first feature value and the second feature value.

A facial-type diagnostic method according to an embodiment of the present disclosure is executed by a computer, the facial-type diagnostic method including: acquiring a first image and a second image, the first image being a captured image of a first facial expression of a user, the second image being a captured image of a second facial expression of the user; extracting a first feature value of a facial part of the user in the first image and a second feature value of the facial part of the user in the second image; and determining a facial type of the user based on the first feature value and the second feature value.

A program according to an embodiment of the present disclosure causes a computer to execute: acquiring a first image and a second image, the first image being a captured image of a first facial expression of a user, the second image being a captured image of a second facial expression of the user: extracting a first feature value of a facial part of the user in the first image and a second feature value of the facial part of the user in the second image; and determining a facial type of the user based on the first feature value and the second feature value.

According to one exemplary embodiment of the present disclosure, it is possible to provide a facial-type diagnostic apparatus, a facial-type diagnostic method, and a program capable of improving the facial type diagnosis accuracy.

### BRIEF DESCRIPTION OF DRAWINGS

FIG. 1 is a schematic diagram of facial-type diagnostic apparatus 100 according to an embodiment of the present disclosure;

FIG. 2 illustrates exemplary facial types;

FIG. 3A illustrates exemplary criteria for determining whether the facial type is of a child face or an adult face;

FIG. 3B illustrates exemplary criteria for determining whether a face gives an impression of curves or an impression of straight lines;

FIG. 4A illustrates an example of feature points used for determination of a facial type;

FIG. 4B illustrates an example of feature points used for determination of the facial type;

FIG. 4C illustrates an example of feature points used for determination of the facial type;

FIG. 4D illustrates an example of feature points used for determination of the facial type;

FIG. 4E illustrates an example of feature points used for determination of the facial type;

FIG. 5 is a block diagram illustrating a hardware configuration of facial-type diagnostic apparatus 100 according to an embodiment of the present disclosure:

FIG. 6 is a block diagram illustrating a functional configuration of facial-type diagnostic apparatus 100 according to an embodiment of the present disclosure;

FIG. 7 is a diagram for explaining exemplary calculation of feature values in which the frequency of a smiling face detected in a certain period is considered:

FIG. 8 is a flowchart illustrating a facial type diagnosis process according to an embodiment of the present disclosure; and

FIG. 9 illustrates a display screen example of a determination result of determining the facial type by the facial type diagnosis process according to an embodiment of the present disclosure.

### DESCRIPTION OF EMBODIMENTS

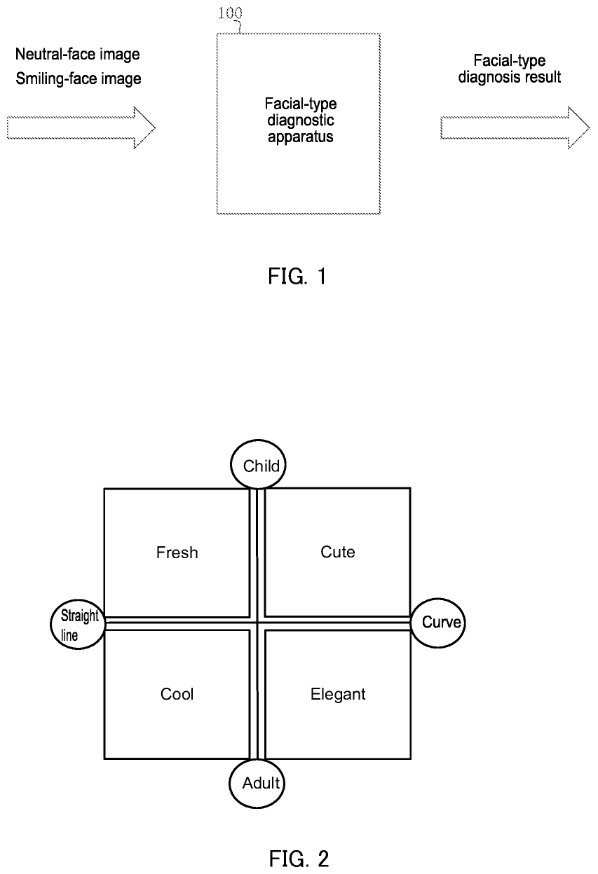

Hereinafter, embodiments of the present disclosure will be described with reference to FIG. 1. FIG. 1 is a schematic diagram of facial-type diagnostic apparatus 100 according to an embodiment of the present disclosure.

As illustrated in FIG. 1, facial-type diagnostic apparatus 100 receives a neutral-face image and a smiling-face image, diagnoses a facial type in consideration of a change in a facial expression of a person based on the received neutral-face image and smiling-face image, classifies the diagnosed face, and outputs the classified face as a diagnosis result. The neutral-face image and the smiling-face image are images of the face of a user captured by the camera. Note that, description of the following exemplary embodiment is focused on two facial expressions of the neutral face and the smiling face, but the present disclosure is not necessarily limited to these facial expressions, and may be applied to a plurality of (any number of) facial expressions different depending on the facial type diagnosis. The number of facial expressions is not limited to two, and may be three or more. However, in general, such facial expressions as anger and sadness are less frequently shown in daily life. It is thus considered that there are few situations in which results of facial type diagnosis considering angry faces and sad faces are useful. Therefore, the present embodiment will be described in relation to an example in which a facial type analysis is performed for a neutral face and a smiling face frequently occurring in daily life.

The facial type diagnosis can be used, for example, in the industry of apparel, makeup, etc., for product promotion. By performing the facial type diagnosis, it is possible to propose, to the user, a product that suits to the facial type classified based on the facial image.

The facial type represents the type of face analyzed from the position, size, shape, and the like of facial parts. The facial parts are parts of a face different in shape, arrangement, color, and the like for each individual. Examples of the facial parts may include parts having specific organ names such as an eye, a mouth, a nose, and an eyebrow, or may be parts not having a specific organ name such as a vertical dimension or a horizontal dimension of a face, an angle of a tip of a chin, a contour of a face, and the like.

### (Facial Type Classification)

The facial type will be described with reference to FIG. 2. FIG. 2 illustrates exemplary facial types. FIG. 2 illustrates a graph of an orthogonal coordinate system with orthogonal vertical and horizontal axes as coordinate axes.

The vertical axis direction represents a tendency of whether the facial type is a child face or an adult face. The child face may have features such as, for example, a rounded contour and relatively low-positioned facial parts including eyes, nose, and the like relative to the contour. The adult face may have features such as, for example, an oblong contour and relatively high-positioned facial parts including eyes, a nose, and the like relative to the contour. Details of criteria for determining whether the facial type is the child face or the adult face will be described later.

The horizontal axis direction represents a tendency of a face giving an impression of curves (which may also be referred to as “face with curves”) or a face giving an impression of straight lines (which may also be referred to as “face with straight lines”). The face with curves may have features including a non-skeletal contour, a rounded chin, rounded eyes, thick lips, thin nasal bridge, and the like. The face with straight lines may have features including a skeletal contour, narrow long-slit eyes, a thin lip, a shapely nose, and the like. Details of criteria for determining whether the face is a face giving an impression of curves or a face giving an impression of straight lines will be described later.

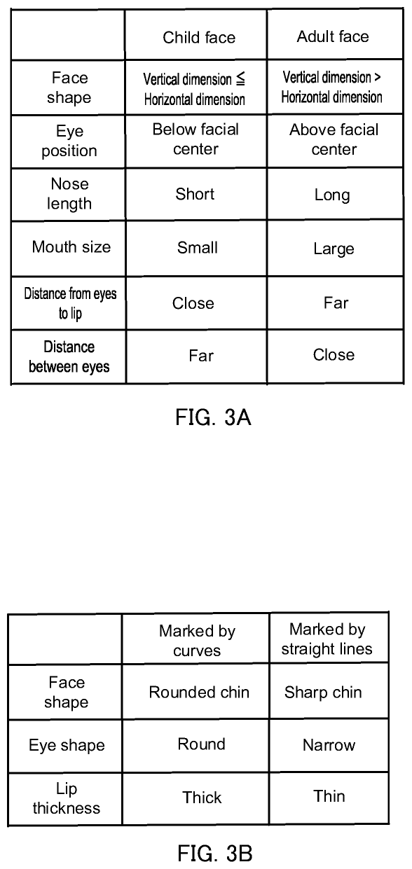

The criteria for determining whether a facial type is the child face or the adult face will be described referring to FIG. 3A. FIG. 3A illustrates exemplary criteria for determining whether a facial type is the child face or the adult face.

Items for determining whether the facial type is the child face or the adult face may include, for example, a face shape (contour), an eye position, a nose length, a mouth size, a distance from eyes to a lip, a distance between the eyes, and the like. As illustrated in FIG. 3A, predetermined criteria are associated with these determination items. By referring to a table in which the determination items and the determination criteria illustrated in FIG. 3A are associated with each other, facial-type diagnostic apparatus 100 may determine whether the facial type is the child face or the adult face.

For example, facial-type diagnostic apparatus 100 may determine the child face when the vertical dimension of the face is equal to or smaller than the horizontal dimension, when the eye position is relatively low (the eyes are located on the chin side) in the face, when the nose length is shorter than a predetermined length, when the mouth size is smaller than a predetermined size, when the distance from the eyes to the lip is less than a predetermined value, when the distance between the eyes is greater than a predetermined value, and the like. On the other hand, facial-type diagnostic apparatus 100 may determine the adult face when the vertical dimension of the face exceeds the horizontal dimension, when the eye position is relatively high (the eyes are located on the forehead side) in the face, when the nose length is longer than the predetermined length, when the mouth size is larger than the predetermined size, when the distance from the eyes to the lip is greater than the predetermined value, when the distance between the eyes is less than the predetermined value, and the like.

Referring to FIG. 3B, the criteria for determining whether a face gives an impression of curves or gives an impression of straight lines will be described. FIG. 3B illustrates exemplary criteria for determining whether a face gives an impression of curves or gives an impression of straight lines.

Items for determining whether a face gives an impression of curves or gives an impression of straight lines may include, for example, a face shape (contour), an eye shape, a lip thickness, and the like. As illustrated in FIG. 3B, predetermined criteria are associated with these determination items. By referring to a table in which the determination items and the determination criteria illustrated in FIG. 3B are associated with each other, facial-type diagnostic apparatus 100 may determine whether the face is a face that gives an impression of curves or a face that gives an impression of straight lines.

For example, facial-type diagnostic apparatus 100 may determine that the face gives an impression of curves, when the chin is rounded, when the eye shape is rounded compared to a predetermined shape, when the lip thickness is thicker than a predetermined dimension, or the like. Meanwhile, facial-type diagnostic apparatus 100 may determine that the face gives an impression of straight lines, when the chin is sharp, when the eye shape is narrower than a predetermined shape, when the lip thickness is thinner than a predetermined dimension, or the like. Note that facial-type diagnostic apparatus 100 may perform the determination of whether the face is the child face or the adult face, and/or determination of whether the face is a face with curves or a neutral face, by integrating evaluation results of a plurality of facial parts, or based on evaluation results of only a single facial part. Further, when determination is performed by integrating the evaluation results of a plurality of facial parts, a further subdivided determination may be performed, which determines a “child face closer to the adult face,” for example, when the face is an adult face according to some facial parts, but most of the facial parts are of the child face.

Accordingly, facial-type diagnostic apparatus 100 may classify the facial types into four types according to the criteria illustrated in FIGS. 3A and 3B.

Specifically, in the case of the child face with curves, facial-type diagnostic apparatus 100 classifies the facial type into a region of “Cute” that gives an impression of brightness, cuteness, and the like (see FIG. 2).

In the case of the child face with straight lines, facial-type diagnostic apparatus 100 classifies the facial type into a region of “Fresh” that gives an impression of vitality, vigor, boyishness, and the like.

In the case of the adult face with straight lines, facial-type diagnostic apparatus 100 classifies the facial type into a region of “Cool” that gives an impression of having accurate insight, dignifiedness and coolness, and the like.

In the case of the adult face with curves, facial-type diagnostic apparatus 100 classifies the facial type into a region of “Elegant” that gives an impression of sophistication.

Facial-type diagnostic apparatus 100 performing such classification displays an image representing the four regions such as “Cute,” “Fresh,” “Cool,” and “Elegant” on a screen on a display as illustrated in FIG. 2, and plots an icon indicating a classification result on the image, thereby providing a facial type of the user. Such display example will be described later.

### (Feature Point of Facial Part)

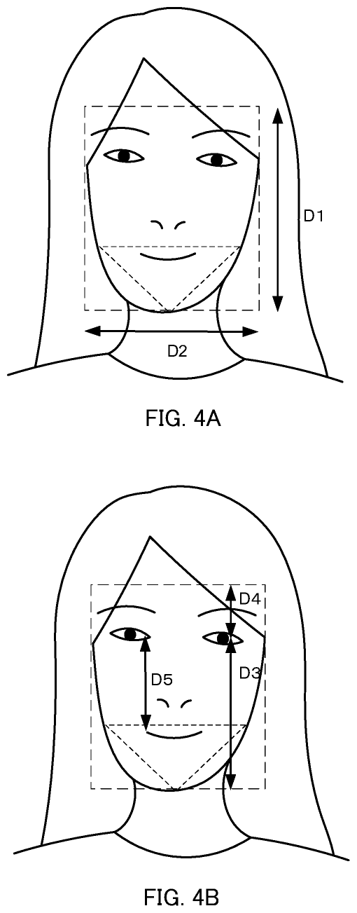

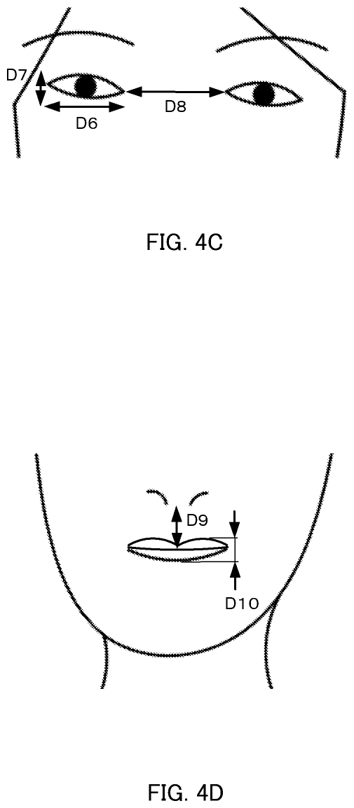

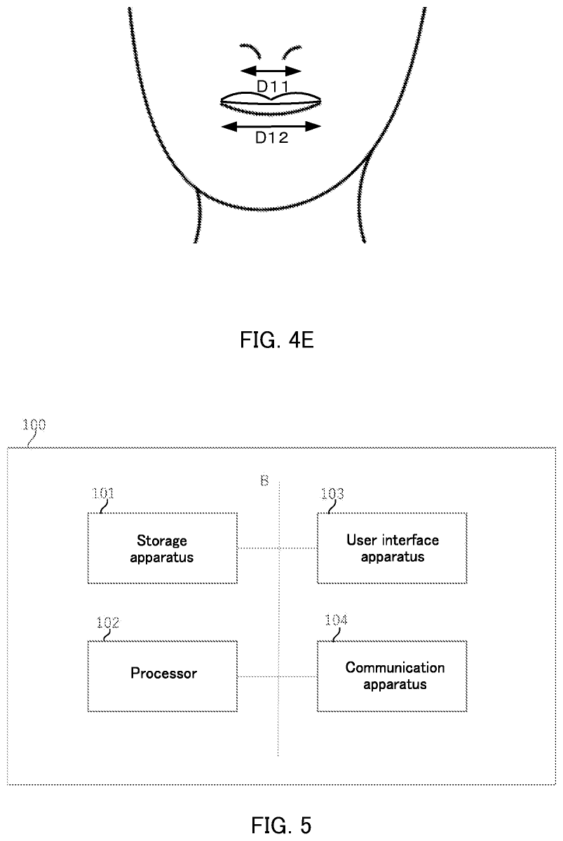

Next, feature points of the facial parts used for the determination of the facial type will be described referring to FIGS. 4A to 4E. FIGS. 4A to 4E illustrate exemplary feature points used for facial type determination.

FIGS. 4A and 4B illustrate the feature points of facial parts such as a facial contour, eyes, mouth, nose, eyebrows, and the like. Facial-type diagnostic apparatus 100 may determine whether vertical dimension D1 of the face is equal to or smaller than horizontal dimension D2 and whether the angle of the distal end of the chin is equal to or larger than a predetermined angle, based on the feature points acquired from a facial image (see FIG. 4A). Facial-type diagnostic apparatus 100 may determine the eye position by comparing dimension D3 from the eye to the lower end of the chin and dimension D4 from the eye to the middle of the forehead based on the feature points (see FIGS. 1 and 4B). Facial-type diagnostic apparatus 100 may determine whether or not distance D5 from the eyes to the lip is less than a predetermined distance based on the feature points (see FIG. 4B).

FIG. 4C illustrates the feature points such as eyes and eyebrows. Based on the feature points, facial-type diagnostic apparatus 100 may determine that the eye is round, when the ratio of vertical dimension D7 of the eye to horizontal dimension D6 of the eye is equal to or greater than a predetermined value, and determine that the eye is narrow when the ratio of vertical dimension D7 of the eye to horizontal dimension D6 of the eye is less than the predetermined value. Based on the feature points, facial-type diagnostic apparatus 100 may determine whether distance D8 between the eyes is greater than a predetermined distance.

FIGS. 4D and 4E illustrate the feature points such as the nose and the mouth. Based on the feature points, facial-type diagnostic apparatus 100 may determine that the lips are thick when the ratio of dimension D10 of the lips to distance D9 between the nose and the mouth is equal to or greater than a predetermined value, and determine that the lips are thin when the ratio of dimension D10 of the lips to distance D9 between the nose and the mouth is less than the predetermined value (see FIG. 4D).

Based on the feature points, facial-type diagnostic apparatus 100 may determine that the mouth is large when the ratio of horizontal dimension D12 of the mouth to horizontal dimension D11 of the nose is equal to or greater than a predetermined value, and determine that the mouth is small when the ratio of horizontal dimension D12 of the mouth to horizontal dimension D11 of the nose is less than the predetermined value (see FIG. 4E).

Next, an exemplary hardware configuration of facial-type diagnostic apparatus 100 will be described with reference to FIG. 5. FIG. 5 is a block diagram illustrating a hardware configuration of facial-type diagnostic apparatus 100 according to the embodiment of the present disclosure.

Facial-type diagnostic apparatus 100 is realized by a computing apparatus such as a smartphone, a tablet, or a personal computer, and may have, for example, the hardware configuration as illustrated in FIG. 5. That is, facial-type diagnostic apparatus 100 includes storage apparatus 101, processor 102, user interface apparatus 103, and communication apparatus 104, which are interconnected to one another via bus B.

Programs or instructions for implementing various functions and processes described later in facial-type diagnostic apparatus 100 may be downloaded from any external apparatus via a network or the like, or may be provided from a removable storage medium such as a Compact Disk-Read Only Memory (CD-ROM) or a flash memory.

Storage apparatus 101 is realized by a random access memory, a flash memory, a hard disk drive, and the like, and stores, together with an installed program or instruction, a file, data, or the like used for executing the programs or instructions. Storage apparatus 101 may include a non-transitory storage medium.

Processor 102 may be implemented by one or more Central Processing Units (CPUs), Graphics Processing Units (GPUs), processing circuitry, and the like, which may be composed of one or more processor cores. Processor 102 performs various functions and processes of facial-type diagnostic apparatus 100 described later, in accordance with data or the like such as programs, instructions, parameters required to execute the programs or instructions stored in storage apparatus 101.

User interface apparatus 103 may include: an input apparatus such as a keyboard, a mouse, a camera, and a microphone: an output apparatus such as a display, a speaker, a headset, and a printer; and an input/output apparatus such as a touch panel, and realizes an interface between the user and facial-type diagnostic apparatus 100. For example, the user operates facial-type diagnostic apparatus 100 by operating a Graphical User Interface (GUI) displayed on the display or touch panel.

Communication apparatus 104 is realized by various communication circuitry that executes a communication process with a communication network such as an external apparatus, the Internet, and a Local Area Network (LAN).

However, the above-described hardware configuration is merely an example, and facial-type diagnostic apparatus 100 according to the present disclosure may be realized by any other suitable hardware configuration. For example, the functions of facial-type diagnostic apparatus 100 may be distributed between and realized by a plurality of computers. In this case, information exchange between the functions of the different computers is performed via a communication network (such as LAN or the Internet) that connects between the computers.

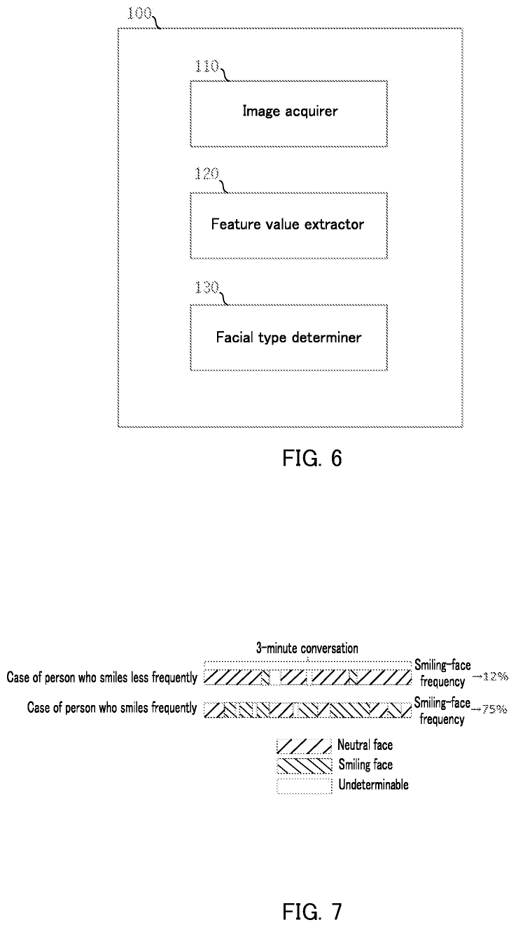

FIG. 6 is a block diagram illustrating a functional configuration of facial-type diagnostic apparatus 100 according to the embodiment of the present disclosure. Facial-type diagnostic apparatus 100 includes image acquirer 110, feature value extractor 120, and facial type determiner 130.

Image acquirer 110 acquires a first image being a captured image of the first facial expression of the user and a second image being a captured image of a second facial expression of the user. The first facial expression may be, for example, a neutral face of the user, and the second facial expression may be, for example, a smiling face of the user.

Specifically, the camera captures an image of the face of the user, and image acquirer 110 acquires the image of the face of the user captured by the camera. The image of the face acquired by facial-type diagnostic apparatus 100 may be a still image or a moving image. The camera captures an image of a measurement target region and generates an RGB image of the measurement target region. For example, the camera may be a monocular camera and generates a monocular RGB image. The generated RGB image is sent to image acquirer 110.

Feature value extractor 120 extracts a first feature value of a facial part of the user in the first image and a second feature value of the facial part of the user in the second image. Specifically, feature value extractor 120 extracts feature points from each of the image of the neutral face of the user and the image of the smiling face, and calculates the feature values of the facial parts corresponding respectively to the determination items based on the extracted feature points. For example, extraction of the feature points from the facial images may be performed by a trained machine learning model. Such a trained machine learning model may be any known model, and may be trained, for example, to extract feature points of a facial image of a subject included in a training facial image by using a plurality of training facial images as teacher data.

The first feature value is, for example, a feature value representing each facial part such as a face shape (contour), an eye shape, a lip thickness, and a chin shape as described above when the user's facial expression is the neutral face. The second feature value is, for example, a feature value representing each facial part such as the face shape (contour), the eye shape, the lip thickness, and the chin shape as described above when the user's facial expression is the smiling face. Note that the feature values of the respective facial parts may be appropriately scaled by normalization or the like so that the subsequent calculation is performed appropriately.

Facial type determiner 130 performs a predetermined calculation on the first feature value and the second feature value based on a first weight set for each facial part and a second weight set for each facial part in each facial expression. Further, facial type determiner 130 determines the facial type of the user based on a calculation result and predetermined determination criterion.

A specific example of processing in facial type determiner 130 will be described below. When the facial expression of the user is the neutral face, facial type determiner 130 assigns a predetermined weight (first weight) set for each facial part to a feature value (first feature value) of the facial part in the case where the facial expression is a neutral face, as given by Expression 1, and further assigns the first feature value a predetermined weight (second weight α) set for each facial part in the case where the facial expression is the neutral face. Facial type determiner 130 sums the feature values of the facial parts to which the weights are assigned.

The feature value for each facial part in the case of the neutral face×the first weight for each facial part×second weight α (Expression 1).

When the facial expression of the user is the smiling face, facial type determiner 130 assigns a predetermined weight (first weight) set for each facial part to the feature value (second feature value) of the facial part in the case where the facial expression is the smiling face as illustrated in Expression 2, and further assigns the first feature value a predetermined weight (second weight) set for each facial part in the case where the facial expression is the smiling face. Facial type determiner 130 sums the feature values of the facial parts to which the weights are assigned.

The feature value for each facial part in the case of the smiling face×the first weight for each facial part×second weight β (Expression 2)

As illustrated in Expression 3, facial type determiner 130 performs a calculation of averaging the feature value to which second weight α in the case of the neutral face is assigned and the feature value to which second weight β in the case of the smiling face is assigned.

(The feature value for each facial part in the case of the neutral face×the first weight for each facial part×second weight α+the feature value for each facial part in the case of the smiling face×the first weight for each facial part×second weight β)/2 (Expression 3)

For example, in the case of curve/straight line determination, facial type determiner 130 performs the calculation expressed in following Expression 4 on the feature values of the neutral face and the smiling face for three facial parts including the face shape, the eye shape, and the lip thickness.

½{(feature value f₁₁ of the face shape of the neutral face×first weight w₁ for the face shape×second weight α₁ for the face shape of the neutral face)+(feature value f₁₂ of the face shape of the smiling face×first weight w₁ for the face shape×second weight β₁ for the face shape of the smiling face)}+½{(feature value f₂₁ of the eye shape of the neutral face×first weight w₂ for the eye shape×second weight α₂ for the eye shape of the neutral face)+(feature value f₂₂ of the eye shape of the smiling face×first weight w₂ for the eye shape×second weight β₂ for the eye shape of the smiling face)}+½{(feature value f₃₁ of the lip thickness of the neutral face×first weight w₃ for the lip thickness×second weight α₃ for the lip thickness of the neutral face)+(feature value f₃₂ of the lip thickness of the smiling face×first weight w₃ for the lip thickness×second weight β₃ for the lip thickness of the smiling face)} (Expression 4).

Note that second weights a and B for each facial expression may be predetermined values given from the outside of facial-type diagnostic apparatus 100 or may be predetermined values set in facial-type diagnostic apparatus 100.

Here, the values of second weight α in the case of the neutral face and second weight β in the case of the smiling face will be described. For example, second weights a and B may be set depending on the susceptibility to influence of a change in the facial expression (the degree of influence due to the facial expression change) for each facial part.

With respect to the facial parts such as an eye, a mouth, and the like that are susceptible to a change in facial expression, facial type determiner 130 may set second weight α in the case of the neutral face such that second weight α is greater than second weight β in the case of the smiling face. This is because the neutral face is the basis of facial type diagnosis.

In addition, with respect to the facial parts such as a contour, a nose, or the like that are insusceptible to a change in facial expression, facial type determiner 130 may set second weight α in the case of the neutral face such that second weight α is equal to second weight β in the case of the smiling face.

For example, when the facial expression changes from the neutral face to the smiling face, the facial expression tends to change such that the degree of opening of the eyes decreases, and also the closed mouth opens largely so that teeth are visible. Accordingly, as described above, the weights for the facial parts which are susceptible to a change in the facial expression are set to different values and the weights for the facial parts which are insusceptible to the change in the facial expression are set to an equal value. It is thus possible to improve the facial type diagnosis accuracy.

As described above, facial type determiner 130 is capable of performing the curve/straight line determination based on the calculation result (4) described above, and of mapping the calculation result to any coordinate on the axis for “Straight line” and “Curve.” Similarly, facial type determiner 130 is capable of performing the calculation for determining the child face/adult face, and mapping the calculation result to any coordinate on the axis for “Child face” and “Adult face.” As a result, facial type determiner 130 is capable of mapping the calculation result as a point on a plane illustrated in FIG. 2, and performing appropriate facial type diagnosis.

Note that the determination process in facial type determiner 130 may include the following modes.

### Variation 1

In the above exemplary embodiment, second weight β in the case of the smiling face is a constant value, but second weight β may be set depending on the degree of a facial expression of the user.

The smiling face, which is the second facial expression, may generally be classified into various smiling-face levels from a smile to a big laugh. Therefore, facial type determiner 130 may further adjust second weight β in the case of the smiling face described above depending on the degree of smiling face (smiling-face levels).

Specifically, facial type determiner 130 may specify the smiling-face level from the smiling-face image by any known measurement technique. For example, facial type determiner 130 may classify the smiling-face image into three smiling-face levels (for example, smiling to such an extent as that of a smile with the mouth closed is classified into level “1,” smiling to such an extent as to slightly open the mouth is classified into level “2,” smiling to such an extent as to wide open the mouth is classified into level “3,” and the like). The smiling-face level according to the present disclosure is not necessarily limited to three levels, and may be classified into any other number of levels.

Then, facial type determiner 130 changes the feature values for the facial parts by assigning smiling-face distribution points a, b, and c, which are coefficients corresponding to the smiling-face levels, to second weights β for the facial parts. For example, smiling-face distribution points a, b, and c may have a relationship of a<b<c.

For example, when it is determined that the smiling-face level is “1,” facial type determiner 130 may further multiply second weight β by smiling-face distribution point a to adjust the feature value of the facial part in the case of the smiling face as follows:

(The feature value for each facial part in the case of the smiling face×the first weight for each facial part×second weight β×smiling-face distribution point a).

When it is determined that the smiling-face level is “2,” facial type determiner 130 may further multiply second weight β by smiling-face distribution point b to adjust the feature value of the facial part in the case of the smiling face as follows:

(The feature value for each facial part in the case of the smiling face×the first weight for each facial part×second weight β×smiling-face distribution point b).

Similarly, when it is determined that the smiling-face level is “3,” facial type determiner 130 may further multiply second weight β by smiling-face distribution point c to adjust the feature value of the facial part in the case of the smiling face as follows:

(The feature value for each facial part in the case of the smiling face×the first weight for each facial part×second weight β×smiling-face distribution point c).

As described above, by calculating the feature value corresponding to the degree of smiling face of the user, it is possible to take into consideration the degree of smiling face to further improve the facial type diagnosis accuracy.

### Variation 2

The above exemplary embodiment has been described in relation to an example in which the facial type is diagnosed based on a still image. Meanwhile, there are people who smile more frequently and people who smile less frequently. By reflecting such a frequency of smiles, a more appropriate facial type diagnosis may be made possible. Specifically, second weight β in the case of the smiling face may be changed depending on the frequency of the smiling face. It is thus possible to perform diagnosis of the facial type according to a living scene. With reference to FIG. 7, a facial type determination process depending on the frequency of smiling faces will be described.

FIG. 7 is a diagram for explaining an example of calculating a feature value in consideration of the frequency of smiling faces detected in a certain period. Image acquirer 110 acquires a video of the user during conversation from the camera for a predetermined period of time, and transmits the acquired video to feature value extractor 120. In the example of FIG. 7, a 3-minute video is acquired.

Feature value extractor 120 calculates the frequency of smiling faces of the user in the video with a predetermined period of time. That is, feature value extractor 120 calculates the frequency of each facial expression of the user in the video with a predetermined period of time. For example, in the specific example illustrated in the figure, the frequency of smiling faces of one user is 12% and the frequency of smiling faces of another user is 75%.

In a case where a video of the user is blurred due to vibration of the camera or the like, feature value extractor 120 may cull, from the video, a part of the video in a time period in which the video cannot be accurately captured and calculate the frequency for each facial expression of the user based on the remaining video. In addition, even when it is not possible to determine whether the face is the neutral face or the smiling face, for example, in a case where a facial part necessary for recognition of the facial expression is hidden or a special facial expression is shown, feature value extractor 120 may cull a part of the video in the corresponding time period, which is unavailable for determination, and calculate the frequency for each facial expression of the user.

Facial type determiner 130 adjusts second weight β depending on the frequency for each facial expression, and performs the above-described calculation on the second feature value based on the adjusted second weight. Specifically, as illustrated in Expression 5, facial type determiner 130 may assign a predetermined coefficient depending on the frequency of smiling faces to second weight β to adjust second weight β so s to apply new second weight β′, new second weight β″, and the like.

The feature value for each facial part in the case of the smiling face×the first weight for each facial part×second weight β′

The feature value for each facial part in the case of the smiling face×the first weight for each facial part×second weight β″ (Expression 5)

Second weight β′ may be a weight corresponding to the frequency of smiling faces of “12%,” and second weight β″ (β′<β″) may be a weight corresponding to the frequency of smiling faces of “75%.”

Note that Variation 1 may be combined with Variation 2, and second weight β in the case of the smiling face may be adjusted in consideration of the smiling-face level and the smiling-face frequency together. For example, when the second weight is set to β′ in accordance with the measured smiling-face frequency and, in addition, when the smiling-face level is “1,” facial type determiner 130 may execute calculation as given in following Expression 6. Here, the smiling-face level may be an average of smiling-face levels in the video.

The feature value for each facial part in the case of smiling face×the first weight for each facial part×second weight β′×smiling-face distribution point a (Expression 6)

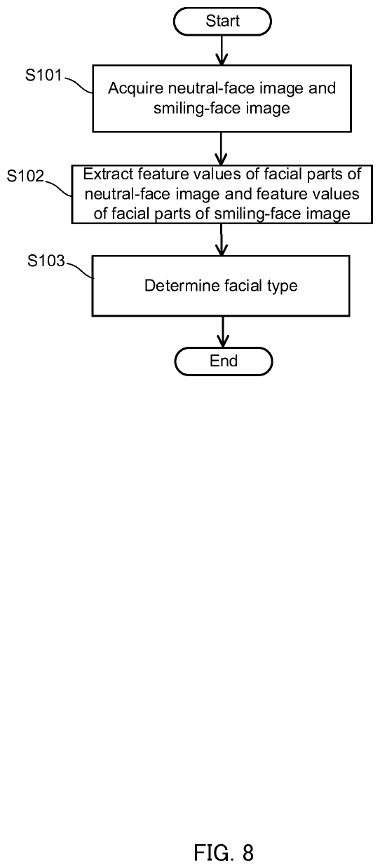

Referring now to FIG. 8, a facial type diagnosis process according to one exemplary embodiment of the present disclosure will be described. The facial type diagnosis process may be executed by facial-type diagnostic apparatus 100 described above, and more specifically, one or more processors 102 of facial-type diagnostic apparatus 100 may execute one or more programs or instructions stored in one or more storage apparatuses 101. For example, the facial type diagnosis process may be started when the user of facial-type diagnostic apparatus 100 activates an application or the like related to the process.

FIG. 8 is a flowchart illustrating the facial type diagnosis process according to an embodiment of the present disclosure. As illustrated in FIG. 8, in step S101, facial-type diagnostic apparatus 100 acquires the neutral-face image and the smiling-face image. Specifically, the camera captures an image of the face of the user for each facial expression, and facial-type diagnostic apparatus 100 acquires the image of the face of the user captured by the camera. The image of the face acquired by facial-type diagnostic apparatus 100 may be a still image or a moving image.

Next, in step S102, facial-type diagnostic apparatus 100 extracts feature values of facial parts of the acquired neutral-face image and feature values of facial parts of the smiling-face image. Specifically, facial-type diagnostic apparatus 100 extracts the feature points of the face of the diagnosis-target user in the neutral-face image and the smiling-face image, and calculates the feature values for the respective facial parts based on the extracted feature points.

Next, in step S103, facial-type diagnostic apparatus 100 performs a calculation of following Expression 7 on the feature values of the neutral face and the smiling face for three facial parts including the face shape, the eye shape, and the lip thickness, for example, for the curve/straight line determination.

½{(feature value f₁₁ of the face shape of the neutral face×first weight w₁ for the face shape×second weight α₁ for the face shape of the neutral face)+(feature value f₁₂ of the face shape of the smiling face×first weight w₁ for the face shape×second weight β₁ for the face shape of the smiling face)}+½{(feature value f₂₁ of the eye shape of the neutral face×first weight w₂ for the eye shape×second weight α₂ for the eye shape of the neutral face)+(feature value f₂₂ of the eye shape of the smiling face×first weight w₂ for the eye shape×second weight β₂ for the eye shape of the smiling face)}+½{(feature value f₃₁ of the lip thickness of the neutral face×first weight w₃ for the lip thickness×second weight α₃ for the lip thickness of the neutral face)+(feature value f₃₂ of the lip thickness of the smiling face×first weight w₃ for the lip thickness×second weight β₃ for the lip thickness of the smiling face)} (Expression 7)

Facial-type diagnostic apparatus 100 is capable of specifying the position on the axis for “Straight line” and “Curve” on the plane illustrated in FIG. 2 based on the calculation result of Expression 7.

Similarly, facial-type diagnostic apparatus 100 is capable of performing a similar calculation on the feature values of the neutral face and the smiling face for six facial parts including the face shape, the eye position, the nose length, the mouth size, the distance from the eyes to the lip, and the distance between the eyes, for example, for the child face/adult face determination, and determining the position on the axis for “Child face” and “Adult face” on the plane illustrated in FIG. 2 based on the calculation result.

Thus, facial-type diagnostic apparatus 100 is capable of determining the position of the facial type of the measurement-target user on the plane illustrated in FIG. 2.

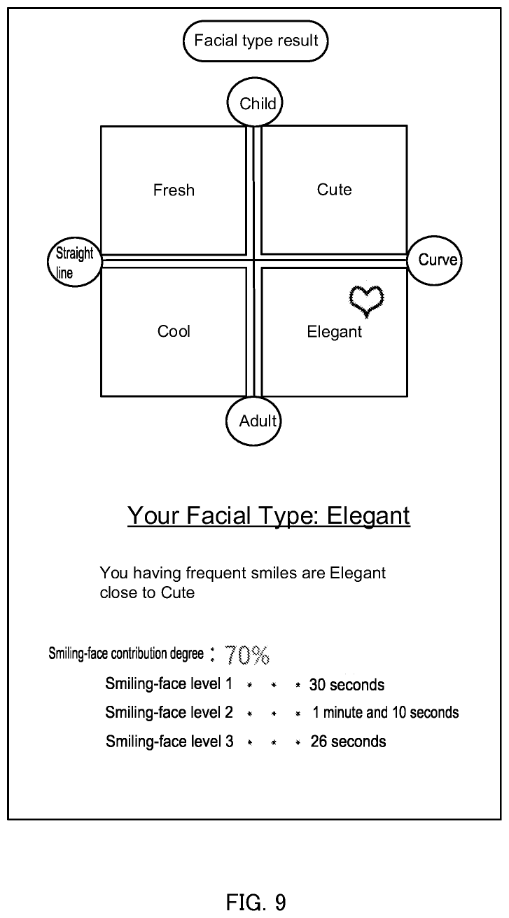

For example, facial-type diagnostic apparatus 100 may provide the facial-type diagnosis result to the user through a display screen as illustrated in FIG. 9. FIG. 9 illustrates an example of the display screen displaying the facial-type diagnosis result by the facial type diagnosis process according to the embodiment of the present disclosure.

Facial-type diagnostic apparatus 100 may display an image representing four regions of “Cute,” “Fresh,” “Cool,” “Elegant,” and the like illustrated in FIG. 9 on a display installed in a cosmetics retailer, for example, and may further display the facial-type diagnosis result (for example, a heart mark) of diagnosis of the measurement-target user on the image.

FIG. 9 illustrates an exemplary display of the facial types determined to be a face that gives an impression of curves, and an image (heart mark) indicating the facial-type diagnosis result is located in the region of “Elegant” at a portion closer to “Cute.”

In addition, facial-type diagnostic apparatus 100 may display guidance describing the facial types next to the screen presenting four regions of “Cute,” “Fresh,” “Cool,” “Elegant,” and the like.

Here, facial type determiner 130 of facial-type diagnostic apparatus 100 may calculate a smiling-face contribution degree indicating a proportion of contribution of the smiling face to the determination of the facial type, and display the calculated smiling-face contribution degree on the screen. In an exemplary embodiment in which the neutral face and the smiling face contribute to the facial type determination by fixed values, the smiling-face contribution degree is also a common value among users. Thus, there is little meaning of calculating the smiling-face contribution degree. Therefore, the smiling-face contribution degree is preferably calculated in an exemplary embodiment in which one or both of the smiling-face level and the smiling-face frequency are taken into consideration.

### (Example of Calculation Formula of Smiling-Face ContributionDegree)

The smiling-face contribution degree in above-described Variation 1 is calculated as given in Expression 8.

Smiling-face contribution degree=(β×smiling-face distribution point)/α+(β×smiling-face distribution point) (Expression 8).

The smiling-face contribution degree in Variation 2 is calculated as given in Expression 9.

Smiling-face contribution degree=(β′×smiling-face distribution point)/α+(β′×smiling-face distribution point)

β′=smiling-face distribution point a×weight γ+smiling-face distribution point b×weight γ′+smiling-face distribution point c×weight γ″ (Expression 9)

Here, γ, γ′, and γ″ are set as weights corresponding to the time lengths of smiling-face levels 1, 2, and 3, respectively. In the display screen of the figure, smiling-face level 1 is 30 seconds, smiling-face level 2 is 1 minute and 10 seconds, smiling-face level 3 is 26 seconds, and in accordance with the above-described calculation formula, the smiling-face contribution degree is calculated as 70%.

As described above, the facial-type diagnostic apparatus according to the embodiment of the present disclosure includes: an image acquirer that acquires a first image and a second image, the first image being a captured image of a first facial expression of a user, the second image being a captured image of a second facial expression of the user; a feature value extractor that extracts a first feature value of a facial part of the user in the first image and a second feature value of the facial part of the user in the second image; and a facial type determiner that performs a first calculation on the first feature value and the second feature value based on a first weight set for each facial part and a second weight set for each facial part in each facial expression, and determines a facial type of the user based on a calculation result and a predetermined criterion.

With this configuration, it is possible to diagnose the facial type based on the feature values of each image of the first facial expression and the second facial expression different from the first facial expression, so as to improve the facial type diagnosis accuracy as compared with the case where the image of a single facial expression is used.

Therefore, when the facial-type diagnostic apparatus according to the embodiment of the present disclosure is applied to a diagnosis dedicated machine installed in, for example, a cosmetics corner of a department store or the like, it is possible to propose a cosmetics optimal for a facial type based on a facial-type diagnosis result of diagnosis in consideration of a change in facial expression. In addition, when the facial-type diagnostic apparatus according to the embodiment of the present disclosure is applied to a diagnosis dedicated machine installed in, for example, an apparel shop, it is possible to propose a garment optimal for a facial type based on a facial-type diagnosis result of diagnosis in consideration of a change in facial expression. In addition, in a case where a part of the functions of the facial-type diagnostic apparatus is implemented by a smartphone or the like, a user may be guided to an online shopping site for optimal cosmetics, an order-made product, or the like based on the facial-type diagnosis result.

### Other Variations

In the above-described embodiment, the diagnosis of the facial type is performed based on the result of assigning a weight to the feature value for each facial part. However, the facial-type diagnostic apparatus may perform the diagnosis of the facial type by using the result of calculation performed while assigning the same weight to all the facial parts or by omitting assignment of a weight to feature values of some or all the facial parts. In addition, in a case where a weight is assigned to the feature value for each facial part, the facial-type diagnostic apparatus may assign a different weight for each facial part. In this case, the facial-type diagnostic apparatus may be configured such that the weight to be assigned increases as the facial part becomes more susceptible to the impression of the facial type.

In the above-described embodiment, the multiplication is performed for assigning the weight during the facial type diagnosis, but the facial-type diagnostic apparatus may assign the weight by another method such as addition.

In the above-described embodiment, the smiling-face contribution degree indicating the proportion of contribution of the smiling face to the determination of the facial type is calculated and displayed. However, the contribution degree to be calculated is not limited to that of smiling faces. For example, the facial-type diagnostic apparatus may calculate and display a neutral-face contribution degree indicating a proportion of the neutral face. In addition, when facial expressions other than the smiling face and the neutral face are also used for the determination of the facial type, the facial-type diagnostic apparatus may calculate and display one or more contribution degrees of the facial expressions.

In the above-described embodiment, only the result considering both the neutral face and the smiling face is displayed as the result of the facial type diagnosis, but the facial-type diagnostic apparatus may also display other results. For example, the facial-type diagnostic apparatus may display a facial type diagnosed only with the neutral face or a facial type diagnosed only with the smiling face. Since it is generally known that smiling faces rather than neutral faces tend to be determined as the child face and a facial type of curves, it is unlikely that a result deviating from this tendency is acquired. However, the degree of change in the facial type between the neutral face and the smiling face is different for each individual. It is thus possible to inform the user of the characteristics of his/her facial expression by visualizing the degree. In a case where facial expressions other than the neutral face and the smiling face are also used for the determination of the facial type, the facial-type diagnostic apparatus may also display a determination result of the facial type based on only each facial expression or an arbitrary combination of the facial expressions. Note that, for example, the following aspects are also understood to fall within the technical scope of the present disclosure.

(1) A facial-type diagnostic apparatus according to an embodiment of the present disclosure includes: an image acquirer that acquires a first image and a second image, the first image being a captured image of a first facial expression of a user, the second image being a captured image of a second facial expression of the user: a feature value extractor that extracts a first feature value of a facial part of the user in the first image and a second feature value of the facial part of the user in the second image; and a facial type determiner that determines a facial type of the user based on the first feature value and the second feature value.

(2) The facial type determiner determines the facial type by comparing a predetermined criterion and a result acquired by performing a calculation using the first feature value and the second feature value.

(3) The facial type determiner performs the calculation by assigning a weight to the second feature value, the weight being set in accordance with a degree of influence due to a facial expression change for each of a plurality of the facial parts.

(4) The image acquirer acquires a video of the user of a predetermined period of time, the feature value extractor calculates a frequency at which the second facial expression of the user is detected in the video, and the facial type determiner executes the calculation by assigning a weight corresponding to the frequency to the second feature value.

(5) The second facial expression is classified into a plurality of facial expression levels, and the facial type determiner assigns a weight depending on the plurality of facial expression levels to the second feature value and executes the calculation.

(6) The facial type determiner further calculates a contribution degree indicating a proportion of contribution of one or both of the first facial expression and the second facial expression to determination of the facial type.

(7) The first facial expression is a neutral face and the second facial expression is a smiling face.

(8) The facial type includes four types classified in accordance with a first determination criterion and a second determination criterion, the first determination criterion being based on a face shape, an eye position, a nose length, a mouth size, a distance from eyes to a lip, and a distance between the eyes, the second determination criterion being based on the face shape, an eye shape, and a lip thickness.

(9) A facial-type diagnostic method according to an embodiment of the present disclosure includes: acquiring a first image and a second image, the first image being a captured image of a first facial expression of a user, the second image being a captured image of a second facial expression of the user; extracting a first feature value of a facial part of the user in the first image and a second feature value of the facial part of the user in the second image; and determining a facial type of the user based on the first feature value and the second feature value.

(10) A program according to an embodiment of the present disclosure causes a computer to execute: acquiring a first image and a second image, the first image being a captured image of a first facial expression of a user, the second image being a captured image of a second facial expression of the user; extracting a first feature value of a facial part of the user in the first image and a second feature value of the facial part of the user in the second image; and determining a facial type of the user based on the first feature value and the second feature value.

Although the exemplary embodiments of the present disclosure have been described in detail above, the present disclosure is not limited to the specific embodiments described above, and various modifications and variations can be made within the scope of the gist of the present disclosure described in the claims.

The disclosure of Japanese Patent Application No. 2021-162949, filed on Oct. 1, 2021, including the specification, drawings and abstract, is incorporated herein by reference in its entirety.

### REFERENCE SIGNS LIST

100 Facial-type diagnostic apparatus
101 Storage apparatus
102 Processor
103 User interface apparatus
104 Communication apparatus
110 Image acquirer
120 Feature value extractor
130 Facial type determiner

1. A facial-type diagnostic apparatus, comprising:
an image acquirer that acquires a first image and a second image, the first image being a captured image of a first facial expression of a user, the second image being a captured image of a second facial expression of the user:
a feature value extractor that extracts a first feature value of a facial part of the user in the first image and a second feature value of the facial part of the user in the second image; and
a facial type determiner that determines a facial type of the user based on the first feature value and the second feature value.

2. The facial-type diagnostic apparatus according to claim 1, wherein
the facial type determiner determines the facial type by comparing a predetermined criterion and a result acquired by performing a calculation using the first feature value and the second feature value.

3. The facial-type diagnostic apparatus according to claim 2, wherein
the facial type determiner performs the calculation by assigning a weight to the second feature value, the weight being set in accordance with a degree of influence due to a facial expression change for each of a plurality of the facial parts.

4. The facial-type diagnostic apparatus according to claim 2, wherein:
the image acquirer acquires a video of the user of a predetermined period of time,
the feature value extractor calculates a frequency at which the second facial expression of the user is detected in the video, and
the facial type determiner executes the calculation by assigning a weight corresponding to the frequency to the second feature value.

5. The facial-type diagnostic apparatus according to claim 2, wherein:
the second facial expression is classified into a plurality of facial expression levels, and
the facial type determiner assigns a weight depending on the plurality of facial expression levels to the second feature value and executes the calculation.

6. The facial-type diagnostic apparatus according to claim 1, wherein
the facial type determiner further calculates a contribution degree indicating a proportion of contribution of one or both of the first facial expression and the second facial expression to determination of the facial type.

7. The facial-type diagnostic apparatus according to claim 1, wherein
the first facial expression is a neutral face and the second facial expression is a smiling face.

8. The facial-type diagnostic apparatus according to claim 7, wherein
the facial type includes four types classified in accordance with a first determination criterion and a second determination criterion, the first determination criterion being based on a face shape, an eye position, a nose length, a mouth size, a distance from eyes to a lip, and a distance between the eyes, the second determination criterion being based on the face shape, an eye shape, and a lip thickness.

9. A facial-type diagnostic method executed by a computer, comprising:
acquiring a first image and a second image, the first image being a captured image of a first facial expression of a user, the second image being a captured image of a second facial expression of the user;
extracting a first feature value of a facial part of the user in the first image and a second feature value of the facial part of the user in the second image; and
determining a facial type of the user based on the first feature value and the second feature value.

10. A program that causes a computer to execute:
acquiring a first image and a second image, the first image being a captured image of a first facial expression of a user, the second image being a captured image of a second facial expression of the user;
extracting a first feature value of a facial part of the user in the first image and a second feature value of the facial part of the user in the second image; and
determining a facial type of the user based on the first feature value and the second feature value.
